(19) United States
(12) Patent Application Publication
(10) Pub. No.: US 2025/0200506 A1
(43) Pub. Date: Jun. 19, 2025

(54) Storage Rack, and Method for Managing the Contents of a Storage Rack

(71) Applicant: Würth International AG, Chur (CH)

(72) Inventors: Adrien Marquette, Schwäbisch Hall (DE); Louisa Aschoff, Neuenstein (DE)

(21) Appl. No.: 18/846,055

(22) PCT Filed: Mar. 9, 2023
(86) PCT No.: PCT/EP2023/056039

§ 371 Date: Sep. 11, 2024

(30) Foreign Application Priority Data
Mar. 16, 2022 (DE) 10 2022 202 595.4

(51) Int. Cl. G06Q 10/087; G06K 7/14; G06K 19/07; G06V 20/52

(52) U.S. Cl. CPC G06Q 10/087; G06K 7/1417; G06K 19/0723; G06V 20/52

(57) ABSTRACT

A storage rack that includes a plurality of storage locations for manually inserting and removing articles is provided for this purpose in which an identification device is assigned to each storage location, where the identification device is designed and arranged in such a way as to identify the article when the article is inserted into the storage rack, when the article is removed from the storage rack and/or after the article has been placed in the storage rack.

### FIELD OF THE INVENTION

The invention relates to a storage rack having a plurality of storage locations for manually inserting and removing articles. The invention also relates to a method for managing the contents of a storage rack.

### BACKGROUND

Storage racks having a plurality of storage locations for manually inserting and removing articles serve, for example in craftsmen's businesses, to store screws, nuts and small parts, articles in general, and to arrange them so that they are readily identifiable and easily removable. A worker or operator, for example, takes a box of screws from the rack before starting work. This normally happens in the morning at the start of work. If the worker then puts any unused screws or boxes of screws, or articles in general, back in the rack in the evening, the worker is normally in a great hurry in the evening as he is keen to finish work for the day. It can therefore be observed that articles or packs of articles are sometimes inserted into a storage rack in an extremely careless manner. As a result, the contents of the storage rack are then no longer arranged in an orderly fashion. If a specific article, for example a specific screw, is then searched for, this is extremely time-consuming, given that, in the worst case, the entire rack must be searched.

### SUMMARY

With the invention, a storage rack having a plurality of storage locations for manually inserting and removing articles, and a method for managing the contents of a storage rack are intended to be improved by means of an electronic facility for providing information relating the contents of the storage rack.

According to the invention, a storage rack having a plurality of storage locations for manually inserting and removing articles is provided for this purpose in which an identification device is assigned to each storage location, wherein the identification device is designed and arranged in such a way as to identify the article when the article is inserted into the storage rack, when the article is removed from the storage rack and/or after the article has been placed in the storage rack.

Information relating to the article itself and to the storage location of the article is known through the identification of the article when it is inserted in, removed from or even after it has been positioned in the storage rack. This information can therefore be provided and retrieved electronically. If a worker then searches for a specific pack containing a plurality of special screws, he can search for these screws in a stock management system and will then be informed of the storage position of the screws. Consequently, he no longer has to search for the article in the entire rack. In addition, with the stock management system, it is also possible to identify that an article in the storage rack is due to run out, for example because only a small quantity of an article is present in the storage rack. The particular advantage of the storage rack according to the invention is that the storage rack is not part of a fully automated storage facility, but is designed for manually inserting and removing articles. Nevertheless, the stock of articles in the storage rack can be managed electronically and particularly if an article is inserted incorrectly, i.e. not at the actually intended storage position, in the storage rack, since this specific article can still be easily found by means of an electronic query relating to the storage position where the desired article is located. With the storage rack according to the invention, the advantages of a storage rack for manually inserting and removing articles are therefore combined with the electronic management of the warehouse stock. According to the invention, the term “articles” generally designates products, components, small parts, e.g. screws, nuts or dowels, and also packs containing a plurality of products, components or small parts, e.g. screws, nuts or dowels.

In one development of the invention, a stock management computer is provided, wherein the stock management computer is designed to provide information relating to storage occupation on the basis of information from the identification device, i.e. indicating the storage location and the quantity of a particular stored article.

In one development of the invention, the identification device has a reading device disposed at the storage location to read a code on the article.

A barcode reading device or a QR code reading device or a reading device to read a numeric code, for example, can be disposed at the storage location.

In one development of the invention, the identification device has an RFID reading device disposed at the storage location.

In this case, every article, for example every pack, must have an RFID chip with a unique identifier. When the RFID chip is queried by means of the RFID reading device, the RFID chip outputs this unique identifier and this identifier can then be assigned to a data set which describes the item or the small parts within a pack.

In one development of the invention, the identification device has a least one camera disposed at the storage location to record at least one image of the article, and an electronic image processing unit to process the image and identify the article.

An article, for example a pack containing a plurality of articles, can also be identified by means of electronic image processing. A pack can be recorded, for example, and an image of the pack can then be created. A code or a description or a symbol on the pack can then be identified by means of electronic image processing, as a result of which the article can be identified.

The problem on which the invention is based is also solved by a method for managing the contents of a storage rack, having the steps of automatically identifying, by means of an identification device, an article manually inserted into or manually removed from a storage space of the storage rack by an operator, wherein the article is identified when it is inserted into the storage location, when it is removed from the storage location and/or after it has been positioned in the storage location, transferring a data set relating to the removed or inserted article to a stock management computer, wherein the data set contains an identification of the article, information indicating whether the article has been inserted or removed, and information for identifying the storage location, and determining current storage occupation of the storage rack by means of the stock management computer.

The method according to the invention enables the electronic management of storage occupation or warehouse stock even in the case of a storage rack for manually inserting and manually removing articles. As a result, the advantages of a storage rack for manually inserting and manually removing articles can be combined with the advantages of electronic stock management.

In one development of the invention, information indicating the storage location at which a specific article is present is provided by the stock management computer.

Thus, when a specific article is searched for, it is possible to identify simply by means of an electronic query where the article, for example a pack containing a plurality of small parts, is located. Consequently, the accidental or careless placement of articles at an incorrect storage location no longer results in the need to search the entire storage rack for a specific article. This results in a considerable timesaving and can prevent high levels of frustration.

In one development of the invention, the determination of a requirement to replenish the storage rack is provided.

A replenishment requirement can be identified since the stock management computer is aware of current storage occupation. A replenishment requirement can be identified, for example, whenever only two pieces of a specific article are still present.

In one development of the invention, the number of articles removed during a predefined time period is taken into account in determining the replenishment requirement for at least one article.

The number of articles removed over a time period of one week, for example, can be taken into account. A replenishment requirement is identified if only this number or a smaller number is then still present in the storage rack.

In one development of the invention, automatic ordering of the determined replenishment requirement is provided. In this way, it can be ensured that a sufficient stock of required articles is always present.

In one development of the invention, the identification of the article by means of an RFID chip on or in the article is provided by means of the reading of a code on the article and/or by means of the recording of at least one image by at least one camera and a subsequent electronic image processing of the image.

An article can be reliably identified by means of RFID chips, by means of a code, for example a barcode or a QR code, or by means of cameras and electronic image processing, even if the article is very hurriedly and manually inserted into or removed from the storage rack. RFID chips can be particularly advantageous here, since an RFID chip can be queried during insertion or removal or even following positioning on the storage rack. The RFID chip is read by means of radio waves and is thereby also comparatively independent from the location of the article in the storage rack.

Further features and advantages of the invention can be found in the claims and the following description of a preferred embodiment of the invention in connection with the drawing. In the drawing:

### BRIEF DESCRIPTION OF THE DRAWINGS

FIG. 1 shows a schematic view of a storage rack according to the invention.

### DETAILED DESCRIPTION

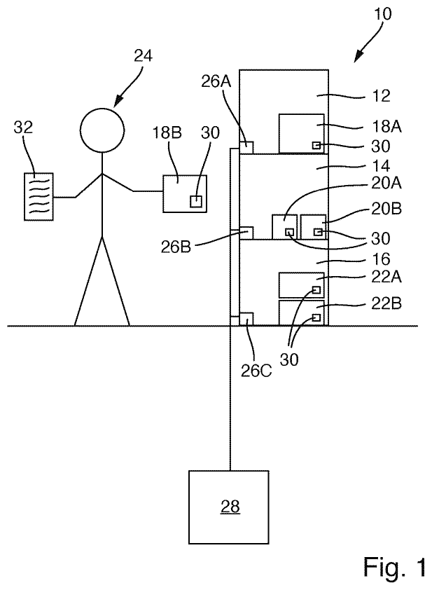

FIG. 1 shows a schematic view of a storage rack 10 having a plurality of storage locations 12, 14, 16. Only three storage locations or rack compartments are shown by way of example in FIG. 1. Substantially more or fewer storage locations 12, 14, 16, can obviously be present according to the invention.

The storage rack 10 is provided for manually inserting and removing articles 18A, 18B, 20A, 20B, 22A, 22B. According to the invention, the term “articles” generally designates products, components, small parts, e.g. screws, nuts or dowels, and also packs containing a plurality of products, components or small parts. This is intended to be illustrated in FIG. 1 by means of an operator 24 holding an article 18B in his hand. The operator 24 can insert the item 18B manually into one of the storage locations 12, 14, 16 of the storage rack 10. The operator can also remove one or more of the articles 18A, 18B, 20A, 20B, 22A, 22B from a respective storage location 12, 14, 16 in the storage rack 10.

The storage rack 10 is provided with an identification device 26A, 26B, 26C at each of the storage locations 12, 14, 16. The identification device 26A is assigned to the storage location 12, the identification device 26B is assigned to the storage location 14 and the identification device 26C is assigned to the storage location 16.

The identification devices 26A, 26B, 26C are connected to a stock management computer 28 and can consequently transmit data to the stock management computer 28.

Each of the articles 18A, 18B, 20A, 20B, 22A, 22B is provided with an RFID chip 30. Each of the RFID chips 30 carries a unique identifier which it outputs during readout. Even if all of the RFID chips 30 in FIG. 1 are therefore identified with the reference number 30, the RFID chips 30 differ in that each of the RFID chips 30 has a different identifier. This identifier is normally designed in the case of RFID chips in such a way that it is a multi-digit number. The multi-digit number is assigned to one single RFID chip only, so that no two RFID chips have the same number as an identifier.

If the operator 24 inserts the article 18B into the storage rack 10, the RFID chip 30 in the article 18B, for example a pack containing a plurality of small parts, is read out during insertion or only when the article 18B is positioned in the respective storage location 12, 14 or 16. The result of this identification is then transmitted from the identification devices 26A, 26B und 26C to the stock management computer 28. If the operator 24 inserts the article which he is holding in his hand into the uppermost storage location 12 in FIG. 1, this is the intended storage location for the item 18B. The identification device 26A can then transmit a data set to the stock management computer 28, said data set on one hand identifying the item 18B and, on the other hand, containing the storage location 12 in which the article 18B is stored.

If the operator 24 mistakenly places the article 18B which he is holding in his hand into the storage location 14, this is identified when the RFID chip 30 in the article 18B is read. In this case, the identification device 26B would then transmit a data set to the stock management computer 28, said data set identifying the article 18B and containing the storage location 14 at which the article 18B is now present.

However, as a result, the stock management computer 28 always has information relating to current storage occupation of the storage rack 10.

If, for example, the operator 24 searches for a specific article 22A, 22B, he can query the storage location at which the article 22A, 22B is present by means of an electronic terminal device, for example a smartphone 32. During this query, he accesses information in the stock management computer 28 and thereby obtains the information that the article 22A, 22B is present in the storage location 16. The stock management computer can, for example, also transmit additional information indicating that only two articles 22A, 22B are still present at the storage location 16. However, an essential feature of the invention is that the operator 24 does not have to search painstakingly for a specific article in all storage locations 12, 14, 16, for example because the desired article is stored at the incorrect storage location, but can obtain the current storage location of the article from the stock management computer 28 using his smartphone 32.

The storage rack 10 therefore combines the advantages of a storage rack for manually inserting and removing articles, i.e. the fast and simple placement and removal of required articles, with the facility to obtain the storage location of a desired article by means of an electronic query. Particularly in the case of large storage racks having numerous storage locations for manual insertion and removal, and also if large numbers of workers or operators 24 are operating at a storage rack 10, a considerable timesaving can be thereby achieved in the search for articles.

Along with an identification of the article and the storage location of an article, further information can obviously also be assigned to an identifier of the respective RFID chip, for example a manufacturer, an address of the manufacturer, processing information such as, for example, rotational speed and torque, and the like.

The stock management computer 28, as implemented, can also initiate automatic reordering so that sufficient articles 18A, 18B, 20A, 20B, 22A, 22B are always available in order to fill the storage rack 10.

1. A storage rack, comprising:
a plurality of storage locations for manually inserting and removing articles,
wherein an identification device is assigned to each storage location,
wherein the identification device is designed and arranged in such a way as to identify the article when the article is inserted into the storage location, when the article is removed from the storage location and/or after the article has been positioned in the storage location.

2. The storage rack as claimed in claim 1, further including a stock management computer, wherein the stock management computer is designed to provide information relating to storage occupation on the basis of information from the identification device by indicating the storage location and the quantity of a particular stored article.

3. The storage rack as claimed in claim 1, wherein the identification device has an RFID reading device disposed at the storage location.

4. The storage rack as claimed in claim 1, wherein the identification device has a reading device disposed at the storage location for reading a code on the article.

5. The storage rack as claimed in claim 1, wherein the identification device has a least one camera disposed at the storage location to record at least one image of the article, and an electronic image processing unit to process the image and identify the article.

6. A method for managing the contents of a storage rack, comprising:
providing automatic identification, by means of an identification device, of an article manually inserted into or manually removed from a storage location of the storage rack by an operator,
wherein the article is identified when the article is inserted into the storage location, when the article is removed from the storage location and/or after the article has been positioned in the storage location,
transferring a data set relating to the removed or inserted article to a stock management computer, wherein the data set contains an identification of the article, information indicating whether the article has been inserted or removed, and information for identifying the storage location, and
determining current storage occupation of the storage rack by means of the stock management computer.

7. The method as claimed in claim 6, further including providing information by means of the stock management computer indicating the storage location at which a particular article is located.

8. The method as claimed in claim 6, further including determining a replenishment requirement of the storage rack.

9. The method as claimed in claim 8, wherein the number of articles removed during a predefined time period is taken into account in determining the replenishment requirement for at least one article.

10. The method as claimed in claim 8, further including automatically ordering the determined replenishment requirement.

11. The method as claimed in claim 6, further including identifying the article by querying an RFID chip on or in the article, by reading a code on the article or on a pack of the article, and/or by recording at least one image of the article or of the pack of the article by means of at least one camera, and a subsequent electronic image processing of the image.
